(19) United States
(12) Patent Application Publication
(10) Pub. No.: US 2025/0112314 A1
(43) Pub. Date: Apr. 3, 2025

(54) BATTERY PACK AND VEHICLE INCLUDING THE SAME

(71) Applicant: LG Energy Solution, Ltd., Seoul (KR)

(72) Inventors: Juhwan Shin, Daejeon (KR); Hyoungsuk Lee, Daejeon (KR); Youngjin Kim, Daejeon (KR); Taekyeong Lee, Daejeon (KR); Namhoon Heo, Daejeon (KR)

(21) Appl. No.: 18/833,049

(22) PCT Filed: Nov. 17, 2022
(86) PCT No.: PCT/KR2022/018150

§ 371 Date: Jul. 25, 2024

(30) Foreign Application Priority Data
Jan. 26, 2022 (KR) 10-2022-0011216

(51) Int. Cl. H01M 50/249; B60L 50/64; H01M 10/613; H01M 10/625; H01M 10/647; H01M 10/6554; H01M 10/656; H01M 50/211; H01M 50/30

(52) U.S. Cl. CPC H01M 50/249; H01M 10/613; H01M 10/625; H01M 10/647; H01M 10/6554; H01M 10/656; H01M 50/211; H01M 50/394; B60L 50/64; H01M 2220/20

(57) ABSTRACT

A battery pack may include a quadrilateral base plate; a quadrilateral under cover spaced apart from the base plate and to face the base plate; a side pack frame connected to an edge of the base plate and an edge of the under cover, and configured to form a periphery of the lower case; and a support beam provided between the base plate and the under cover. The support beam may include a hollow pipe having an end connected to the side pack frame. A base vent hole may be provided at an area of the base plate facing the support beam and a beam vent hole may be provided at an area of the support beam facing the base vent hole. The hollow portion of the support beam may be in communication with a frame hollow portion of the side pack frame. The frame hollow portion may be connected to a pack vent.

This application is a National Stage of PCT/KR2022/018150, filed Nov. 17, 2022, which claims priority to Patent Application No. 10-2022-0011216 filed in the Republic of Korea on Jan. 26, 2022 all of which are hereby expressly incorporated by reference into the present application.

### TECHNICAL FIELD

The present disclosure relates to a battery pack for a vehicle accommodating a secondary battery and a vehicle including the same.

### BACKGROUND

Electric vehicles using electricity as a driving force are becoming widespread. An electric vehicle is equipped with secondary batteries storing energy. The secondary battery is provided in a vehicle as a battery pack connected in parallel and/or series to provide voltage and current suitable for driving a motor to drive the vehicle.

Since it is quite heavy, the battery pack is mounted on the floor of a vehicle to ensure the driving stability of the vehicle. Accordingly, the battery pack generally has a rectangular parallelepiped shape with a low height.

To secure the rigidity of the rectangular battery pack with a wide area and a low height, a reinforcing member having a shape of a crossbeam is usually provided between secondary cells accommodated in the battery pack.

However, when the reinforcing member has such a crossbeam shape, the space for accommodating the secondary battery is reduced as much as the space occupied by the reinforcing member.

Meanwhile, when a short circuit occurs in the secondary battery due to an external shock or the like, heat might be generated and this heat might cause the secondary battery to ignite or explode. Therefore, a structure is required which may prevent the secondary battery from exploding by quickly discharging gas generated when the secondary battery generates heat at an abnormally high temperature. Accordingly, a venting structure for venting the gas generated in the secondary battery is separately provided in the battery pack.

However, the structure for the gas venting also occupies a space capable of accommodating the secondary battery, and thus the space capable of accommodating the secondary battery is reduced.

Such a conventional battery pack structure is disclosed in KR 2065099 B1, KR 2021-0017273 A, KR 2018-0006150 A, and KR 2021-0041950 A

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Accordingly, one aspect of the present disclosure is to solve the above-noted disadvantages of the prior art, and to provide a battery pack structure in which a structure for reinforcing rigidity does not occupy a space for accommodating a secondary battery, and a vehicle to which the battery pack is applied.

Further, another aspect of the present disclosure is to provide a battery pack structure that may quickly discharge gas generated due to abnormal heat of a secondary battery and also may not occupy a space accommodating the secondary battery, and a vehicle including the same.

Still further, a further aspect of the present disclosure is to provide a battery pack structure that may sufficiently ensure rigidity with a simple structure and may secure a space for accommodating a secondary battery, and a vehicle including the same.

Still further, a further aspect of the present disclosure is to provide a battery pack structure that may secure a space for accommodating a secondary battery, even with a simple structure configured to suppress prevention and spread of a fire due to abnormal heat of a secondary battery, and a vehicle including the same.

Aspects of the present disclosure are not limited to the above, and other aspects and advantages of the present disclosure will be understood by the following description and will be more definitely understood through the embodiments of the present disclosure. It is also to be easily understood that the aspects and advantages of the present disclosure may be realized and attained by means and a combination thereof described in the appended claims.

A battery pack of the present disclosure may solve the above-noted disadvantages and may include a quadrilateral lower case extending in a first direction and a second direction crossing the first direction.

The first direction may be a width direction of a rectangular shape and the second direction may be a longitudinal direction of a rectangular shape.

The first direction may be a direction in which a short side of the rectangular shape extends, and the second direction may be a direction in which a long side of the rectangular shape extends.

The first direction may be a direction corresponding to a width direction of a vehicle, and the second direction may be a direction corresponding to a front-rear direction of a vehicle.

The battery pack may be a flat rectangular parallelepiped shape with a low vertical height.

The lower case may include a rectangular base plate, a rectangular under cover, a side pack frame connected to an edge of the base plate and an edge of the under cover.

The base plate and the under cover may face each other in a vertical direction, spaced apart from each other.

The base plate may be disposed more upward than the under cover.

The side pack frame may include a pair of members extending in a first direction and a pair of members extending in a second direction.

The pair of the members extending in the first direction may be short side members.

The pair of the members extending in the second direction may be long side members.

A support beam may be provided between the base plate and the under cover, and extending in a first direction:

Both extension-direction ends of the support beam may be connected to the side pack frame.

The support beam may be connected to the pair of the members extending from the side pack frame in the second direction.

The side pack frame may further include a wall frame extending more upward than the base plate.

A plurality of pouches may be disposed inside a space surrounded by the wall frame as an upper space of the base plate.

The support beam may support the pouches and reinforce rigidity of the lower case.

No member for reinforcing rigidity of the lower case may be disposed between two pouches adjacent to each other in the first direction or the second direction. Accordingly, more pouches may be accommodated inside the battery pack.

The plurality of pouches may be in contact with each other in the second direction.

The support beam may be provided in plural.

The plurality of support beams may be spaced apart from each other in the second direction.

The plurality of support beam may be in parallel with each other.

Both extension-direction ends of the support beam may be connected to the side pack frame, thereby further reinforcing rigidity.

A base vent hole may be provided in a predetermined area of the base plate facing the support beam.

A beam vent hole may be provided on an upper surface of the support beam facing the base vent hole.

The base vent hole and the beam vent hole may be in communication with each other.

The support beam may include a beam hollow portion having a hollow along a direction in which the support beam extends.

The support beam may have a rectangular cross section, and a top of the support beam may be an open ‘U’-shape.

The beam vent hole and the beam hollow portion may be in communication with each other.

An end vent hole may be provided at one end of at least one side of the support beam.

The end vent hole may be provided at each of the both ends of the support beam.

The beam hollow portion and the end vent hole may be in communication with each other.

A beam connection hole in communication with the end vent hole may be provided at the side pack frame in an area where the side pack frame is connected to the support beam.

The side pack frame may include a frame hollow portion extending in a second direction.

The side pack frame may further include an edge frame extending more outward in a lateral direction than the base plate and the under cover.

A lateral-direction inner end of the edge frame may be connected to a lower area of the wall frame.

The frame hollow portion may be provided in the edge frame.

The frame hollow portion may be in communication with the beam connection hole.

The lower case may further include a pack vent configured to discharge gas from the pouch.

The pack vent may be provided in the member of the side pack frame extending in the first direction, that is, a short side member.

The frame hollow portion may be connected with the pack vent.

The base plate and the pouch may be secured to each other by a resin disposed between the base plate and the pouch.

A cooling plate may be disposed on a lower surface of the base plate and the cooling plate may include a cooling path.

The support beam may be disposed lower than the cooling plate.

The base bent hole of the base plate may be provided in an area where the cooling path is not disposed.

A corresponding vent hole may be provided in an area of the cooling plate facing the base vent hole.

The base vent hole and the corresponding vent hole may be in communication with each other.

The base plate and the pouch may be secured to each other by the resin disposed between the base plate and the pouch.

The resin may not be disposed on an area extending along a second direction to provide a plurality of base vent holes arranged along the second direction.

A vent hole may be provided on a lower surface of the pouch at a position corresponding to the area where the resin is not disposed, and configured to discharge gas generated inside the pouch to an outside.

Gas leaking from the pouch may be discharged by the pack vent through the base vent hole, the corresponding hole, the beam vent hole, the beam hollow portion, the end vent hole, the beam connection hole, and the frame hollow portion in a flow order.

The pouch may be a pouch unit (e.g., SPU: Scalable Pouch Unit).

A vehicle according to an embodiment of the present disclosure may include the battery pack mounted therein.

The battery pack according to the present disclosure may secure more space for accommodating the secondary battery, thereby increasing the electricity capacity of the battery pack.

In addition, the battery pack according to the present disclosure may secure the sufficient electricity capacity and ensure rigidity of the battery pack at the same time.

In addition, the battery pack according to the present disclosure may use the structure for reinforcing the rigidity of the lower case as the gas discharge path, thereby reducing the weight of the battery pack while securing the space for accommodating the pouch.

In addition, the battery pack according to the present disclosure may be lighter and have the larger electricity capacity, thereby securing the more movable distance of the vehicle when it is mounted in the vehicle.

In addition to the above-described effects, specific effects of the present disclosure will be described together with the following detailed description for implementing the present disclosure.

### BRIEF DESCRIPTION OF DRAWINGS

FIG. 1 is a front perspective view of a lower case applied to a battery pack according to the present disclosure;

FIG. 2 is a rear perspective view of the lower case of FIG. 1:

FIG. 3 is a bottom view of the lower case of FIG. 1:

FIG. 4 is a bottom view of a state where an undercover is deleted from FIG. 3:

FIG. 5 is a bottom view of a state where a support beam is deleted from FIG. 4:

FIG. 6 is a VI sectional view of FIGS. 1 and 2:

FIG. 7 is a perspective view of a pouch disposed inside a lower case:

FIGS. 8 and 9 are views showing a process of disposing the pouch of FIG. 7 inside the lower case of FIG. 1:

FIG. 10 is a view showing a state where the pouch is completely accommodated in the lower case of FIG. 1:

FIG. 11 is a XI sectional view of FIG. 10; and

FIG. 12 a perspective view of a vehicle to which the battery pack is applied.

### DETAILED DESCRIPTION

The above aspects, features and advantages will be described later in detail with reference to the accompanying drawings, and accordingly, those skilled in the art to which the present disclosure belongs will be able to easily implement the technical idea of the present disclosure. In describing the present disclosure, if it is determined that the detailed description of the known technology related to the present disclosure may unnecessarily obscure the subject matter of the present disclosure, the detailed description may be omitted. Hereinafter, preferred embodiments according to the present disclosure will be described in detail with reference to the accompanying drawings. In the drawings, the same reference numerals may be used to indicate the same or similar components.

Although “first”, “second”, and the like may be used to describe various components, these components are not limited by these terms. These terms are only used to distinguish one component from another component, and unless otherwise stated, the first component may be the second component.

Throughout the specification, unless otherwise stated, each component may be singular or plural.

Hereinafter, the arrangement of an arbitrary component on the “upper portion (or lower portion)” or “upper (or lower)” of a component may mean that an arbitrary component is placed in contact with the upper (or lower) surface of the component. In addition, it may mean that other components may be interposed between the component and any component disposed on (or under) the component.

In addition, when a component is described as “linked”, “coupled” or “connected” to another component, the components may be directly connected or connected to each other, but other components may be “interposed” between each component. “, or each component may be “linked”, “coupled” or “connected” through other components.

Throughout the specification, unless otherwise stated, each component may be singular or plural.

Singular expressions used herein include plural expressions unless the context clearly dictates otherwise. In this application, terms such as “consisting of” or “comprising” should not be construed as necessarily including all of the various components or steps described in the specification. It should be construed that it may not include some of the components or some of the steps. Or may further include additional components or steps.

Throughout the specification, when it says “A and/or B”, it means A, B or A and B, unless otherwise specified, and when it says “C to D”, it means C or more and D or less, unless otherwise specified.

Hereinafter, preferred embodiments of the present disclosure will be described referring to the accompanying drawings.

For description convenience, on the plane including a first direction and a second direction, which will be described later, a direction directed to an inside of a rectangular lower case is referred to as an inward direction, and a direction directed to an outside of the lower case is referred to as an outward direction.

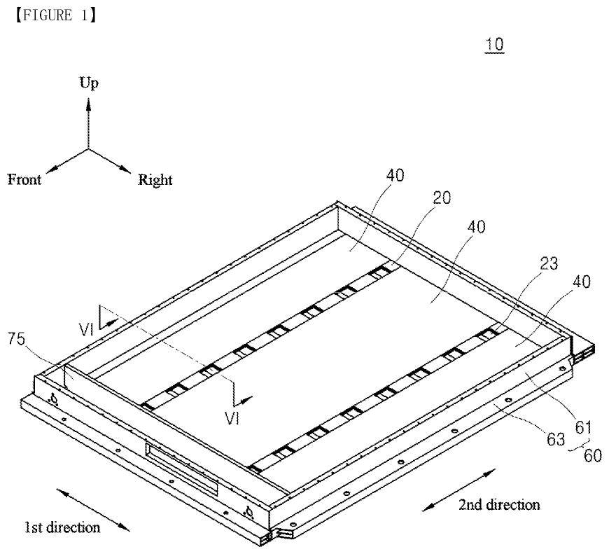

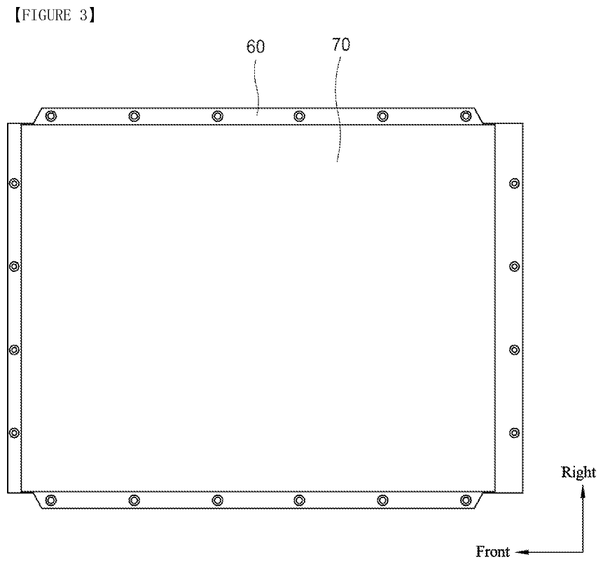

Hereinafter, referring to FIGS. 1 to 6, an embodiment of a lower case 10 provided in a battery pack 3 applied to a vehicle according to an embodiment of the present disclosure will be described.

The lower case 10 may extend in a width direction (i.e., a first direction) and a front-rear direction (i.e., a second direction), and may be applied to a battery pack having a low height. That is, the battery pack 3 may have a flat wide rectangular parallelepiped shape.

The lower case 10 may have a rectangular plane extending in the width direction and the front-rear direction crossing the width direction, and a predetermined height.

A side corresponding to the width direction of the lower case 10 may be a short side, and a side corresponding to the front-rear direction may be a long side.

The extending direction of the short side may be the same as the width direction of a vehicle in which the battery pack 3 is installed. The extending direction of the long side may be the same as the front-rear direction of the vehicle. However, the installation direction of the battery pack 3 according to the present disclosure is not limited thereto.

The lower case 10 may include a rectangular base plate 20 and a rectangular under cover 70 corresponding to the base plate 20.

The under cover 70 may have a shape of rectangular flat plate slightly larger than the base plate 20.

The lower case 10 may further include a side pack frame 60 connected to an edge of the base plate 20 and an edge of the under cover 70.

The side pack frame 60 may have an approximately ‘L’-shaped cross section. The side pack frame 60 may include a wall frame 61 connected with the base plate 20 and extending upward, and an edge frame 63 connected with the under cover 70 and extending outward and rearward.

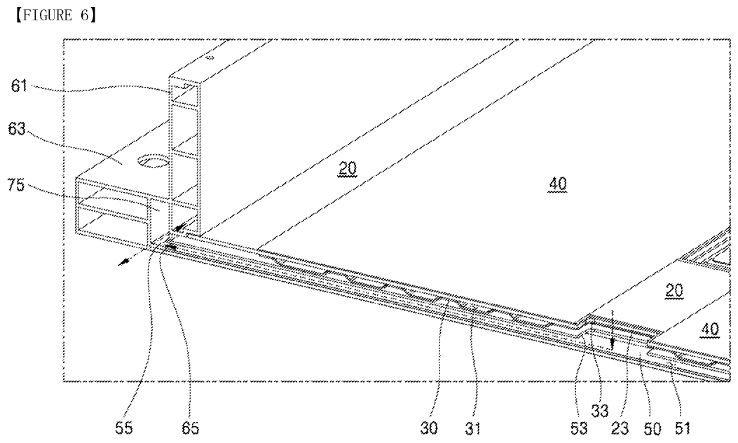

Referring to FIG. 6, the edge frame 63 may be connected to a lower outer surface of the wall frame 61 and extend outward from the wall frame 61. A lower end of the edge frame 63 may extend lower than the lower end of the wall frame 61. Accordingly, an inner surface of the edge frame 63 may be disposed more outward than an inner surface of the wall frame 61, and a lower surface of the edge frame 63 may be disposed lower than a lower surface of the wall frame 61. The lower surface of the wall frame 61 may be disposed more inward than the lower surface of the edge frame 63.

The wall frame 61 and the edge frame 63 may be hollow extruded members having predetermined partition walls therein. Accordingly, the side pack frame 60 may secure rigidity while minimizing the weight.

A step may be provided on an inside of the lower surface of the wall frame 61. An edge of the base plate 20 may be fixedly fitted to the step, so that the base plate 20 and the wall frame 61 may be mutually regulated at the positions and fixed to each other. In an embodiment, the lower surface of the base plate 20 and the lower surface of the wall frame 61 may form the same plane.

A step may be provided on an inside of the lower surface of the edge frame 63 and an edge of the under cover 70 may be fixedly fitted to the step, so that the under cover 70 and the edge frame 63 may be mutually regulated at the positions and fixed to each other. In an embodiment, the lower surface of the under cover 70 and the lower surface of the edge frame 61 may form the same plane.

Accordingly, the base plate 20 may be disposed higher than the under cover 70, and may be spaced apart from the under cover 70, facing each other in a vertical direction.

The side pack frame 60 may be coupled to four sides of the base plate 20 and four sides of the under cover 70, while surrounding the sides. The side pack frame 60 may include a pair of short side members extending in a first direction, and a pair of long side members extending in a second direction.

The wall frame 61 may extend more upward than an upper surface of the base plate 20. Accordingly, a predetermined space may be defined by the inner surface of the wall frame 61 and the upper surface of the base plate 20, and a plurality of pouches 90 may be disposed inside the space.

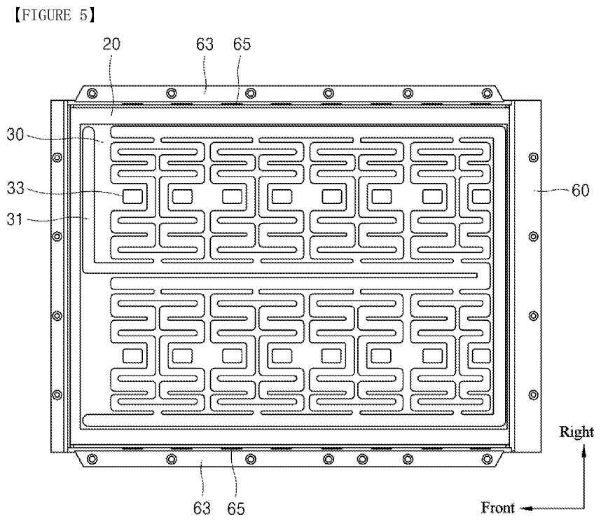

A cooling plate 30 may be disposed on a lower surface of the base plate as shown in FIG. 5. The cooling plate 30 may have a predetermined portion in close contact with the lower surface of the base plate 20 and another portion spaced a preset distance apart from the base plate 20. The portion spaced a preset distance apart from the base plate 20 and a corresponding portion of the lower surface of the base plate 20 may define a cooling path 31 through which a cooling fluid flows.

The cooling fluid for cooling a secondary battery may be supplied to the cooling path 31 through an inlet of the cooling path 31, and cool the secondary battery while flowing through the cooling path 31 to return through an outlet of the cooling path 31.

A support beam 50 may be provided between the cooling plate 30 and the under cover 70. An upper surface of the support beam 50 may face the cooling plate 30, in contact, and a lower surface thereof may face the under cover 70, in contact.

The support beam 50 may be an approximately flat rectangular square tube extending in the first direction. In other words, the support beam 50 may have a pipe-shaped member extending in the first direction, with a beam hollow portion 51. Accordingly, an end vent hole 55 may be provided at each of both ends of the support beam 50.

Both first-direction ends of the support beam 50 may be fixedly connected to the side pack frame 60. Specifically, the end of the support beam 50 may be fixed to a corner between a lower surface and an inner surface of the edge frame 63.

A beam connection hole 65 may be provided at the corner between the lower surface and the inner lateral surface of the edge frame 63. The beam connection hole 65 may be formed by removing a predetermined area of the lower surface and a predetermined area of the inner lateral surface of the edge frame 63.

A lower portion of the support beam 50 may be in contact with a side area of the lower surface of the edge frame 63 exposed by the beam connection hole 65. An upper portion of the support beam 50 may be in contact with a lower area of the inner lateral surface of the edge frame 63.

Through the beam connection hole 65 and the end vent hole 55 fitted to each other, the frame hollow portion 67 provided in the edge frame 63 of the side pack frame 60 and the beam hollow portion 51 of the support beam 50 may be connectedly in communication.

The connection method between the support beam 50 and the side pack frame 60 is not limited to the above-noted embodiment. For example, other connecting methods may be possible if the beam hollow portion 51 of the support beam 50 and the frame hollow portion 67 of the side pack frame 60 are connected with each other in communication.

The support beam 50 may extend in a direction corresponding to the short side of the lower case 10, and may have both ends connected to the pair of the side pack frames 60 provided in the long side of the lower case 10. Alternatively, the support beam 50 may extend in a direction corresponding to the long side of the lower case 10, and may be connected to a pair of side pack frames 60 provided in the short side of the lower case 10.

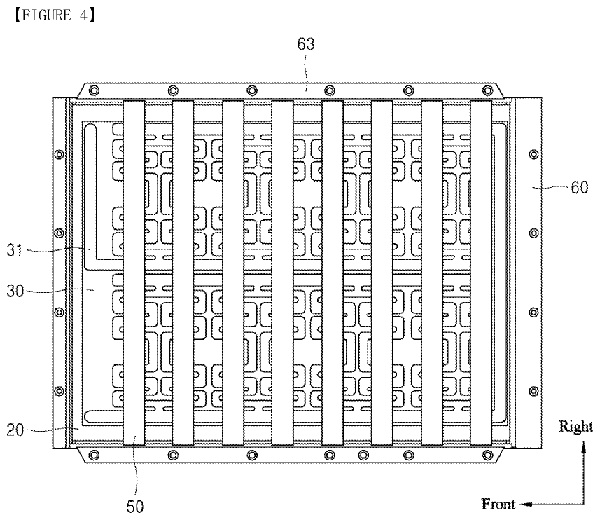

Referring to FIG. 4, a plurality of support beams 50 may be spaced a preset distance apart from each other along the second direction. Also, both ends of each support beam 50 may be connected to the side pack frame.

Referring to FIGS. 1 and 5, the base plate 20 and the cooling plate 30 may include a base vent hole 23 and a corresponding vent hole 33, respectively. The base vent hole 23 and the corresponding vent hole 33 may be provided in an area out of the cooling path 31.

In an embodiment, a pair of a base vent hole and a corresponding vent hole 33 may be provided along the first direction. The pair of the base vent hole 23 and corresponding vent hole 33 may be arranged at regular intervals along the second direction. Referring to FGS. 1 and 5, a plurality of base vent holes and the corresponding vent holes 33 may be arranged in two rows along the second direction.

Referring to FIG. 4, one support beam 50 may be disposed at a position passing under the pair of the base vent hole 23 and corresponding vent hole 33 arranged in the first direction. accordingly, the plurality of support beams 50 spaced a preset distance apart from each other along the second direction may be disposed below the pair of the base vent hole 23 and corresponding vent hole 33 spaced a preset distance apart from each other along the second direction.

A beam bent hole 53 may be provided at a position on the upper surface of the support beam 50 that corresponds to the base vent hole 23 and the corresponding vent hole 33. According to an embodiment, a pair of beam vent holes 53 may be provided on one support beam 50. That is, the support beam 50 according to the embodiment is a flat square tube having a beam hollow portion 51, is provided with end vent holes 55 at both longitudinal ends thereof, and is provided with the pair of beam vent holes 53 on an upper surface thereof.

The space accommodating the secondary battery pouch 90 inside the lower case 10 may be in communication with the frame hollow portion 67 of the side pack frame 60 through the base vent hole 23 of the base plate 20, the corresponding hole 33 of the cooling plate 30, the beam vent hole 53, the beam hollow portion 51, and the end vent hole 55 of the support beam 50, and the beam connection hole 65 of the side pack frame 60 in order.

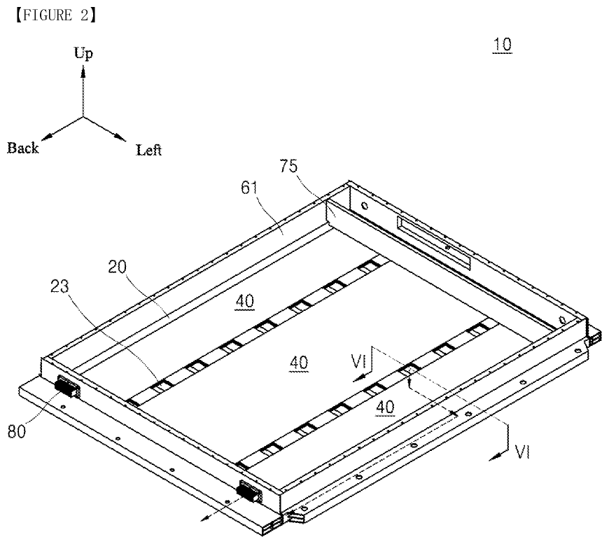

The frame hollow portion 67 may extend along the longitudinal direction of the side pack frame 60. The frame hollow portion 67 may be connected to a pack vent 80 provided at the side pack frame 60. In an embodiment, the pack vent 80 may be configured to be mounted to an outer surface of the wall frame 61 of the side pack frame 60 disposed on a rear short side of the lower case 10, as shown in FIG. 2.

A plurality of pouches 90 may be disposed inside a space which is surrounded by the wall frame 61 and has a bottom defined by the base plate 20.

To secure the pouches 90 on the base plate 20, resin 40 may be attached or coated on an upper surface of the base plate 20. The resin 40 may be provided at a predetermined portion except the base vent holes 23 disposed in two rows along the second direction. The resin 40 may not be provided at the two-row area passing the base vent holes 23 along the second direction. The resin 40 may be thin but have a predetermined thickness. Accordingly, even while the pouch 90 is mounted on the resin 40, the two base vent holes adjacent to each other in the second direction may be in communication through the area having no resin 40, that is, a predetermined space provided on the base plate.

The support beam 50 may be configured to support the pouch 90 and reinforce rigidity of the lower case 10. The support beam may provide even a path for discharging gas which might leak from the pouch 90.

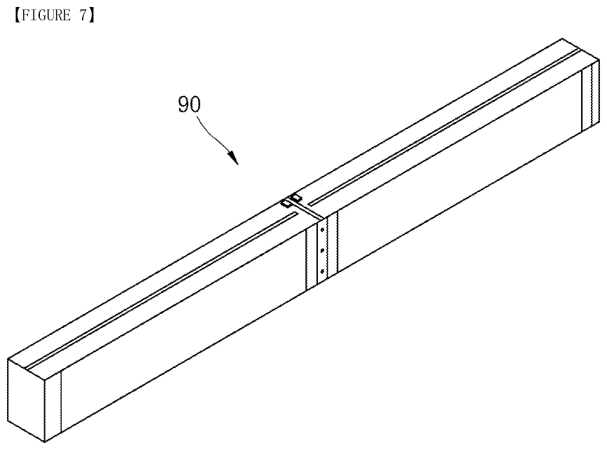

As shown in FIG. 7, the secondary battery pouch 90 may have a thin long parallelepiped shape. The pouch 90 may be a scalable pouch unit.

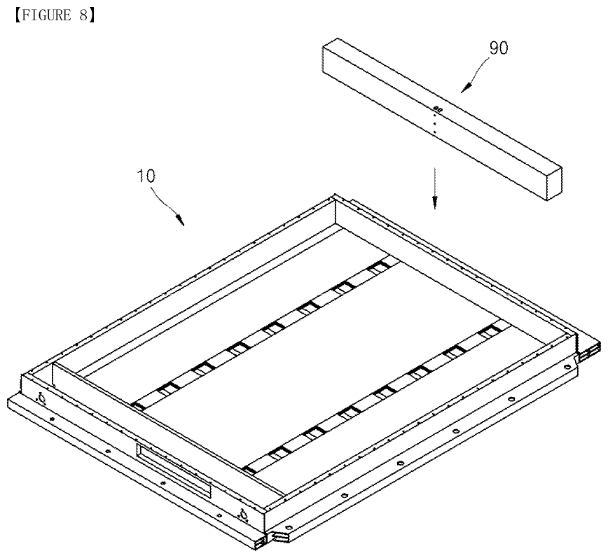

Referring to FIGS. 8 to 11, the pouch 90 may be accommodated inside the lower case 10 in a state of being aligned to extend in the first direction. At this time, a plurality of the pouches 90 may be accommodated in a state of being arranged along the second direction.

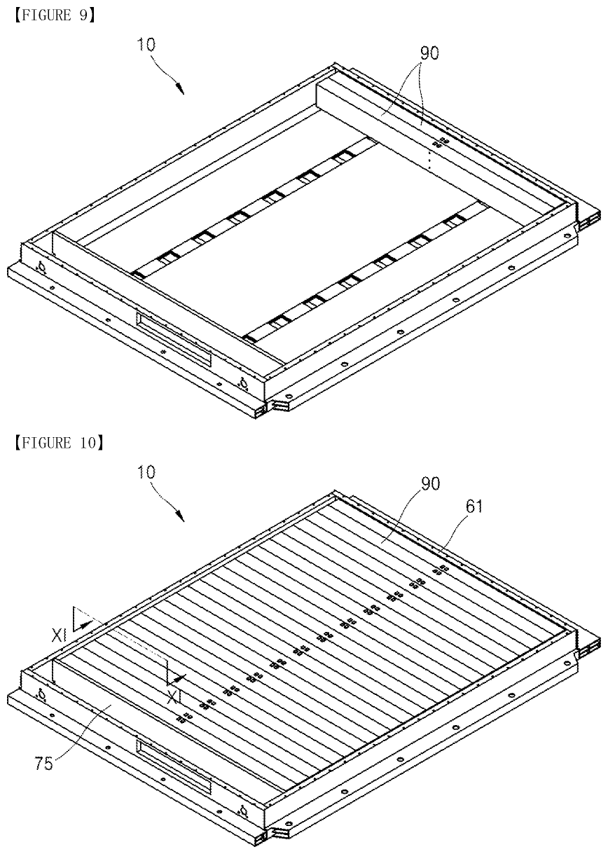

As shown in FIG. 10, no structure for reinforcing the lower case may be disposed between two pouches 90 adjacent to each other in the second direction, in a state where the pouches 90 are accommodated inside the lower case 10. In other words, all of the pouches 90 may be arranged to contact each other in the second direction. Accordingly, it is possible to accommodate more pouches 90 inside the lower case 10 of the battery pack 3.

The plurality of pouches 90 may be disposed between the wall frame 61 provided in the rear and a partition wall 75 provided in the front. Other components may be accommodated inside a space defined between the partition wall 75 and the wall frame 61 provided in the front.

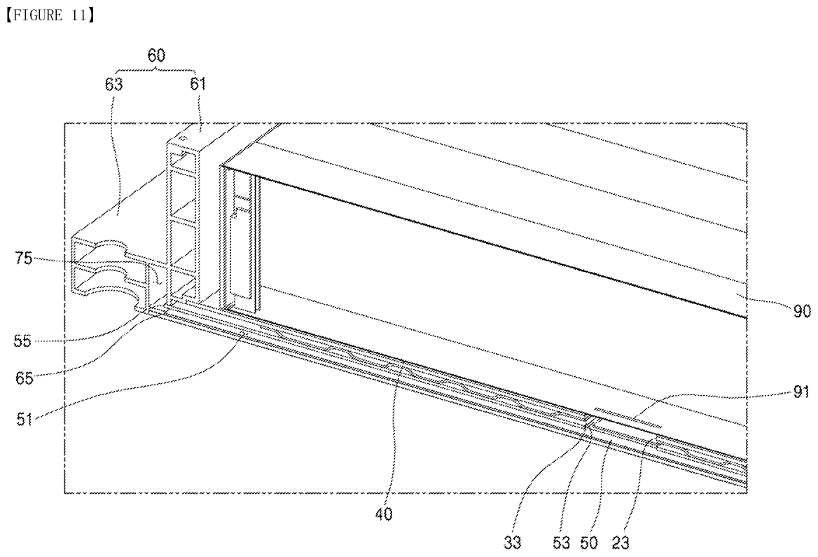

Referring to FIG. 11, a vent hole 91 may be provided in a lower area of the pouch 90 to discharge gas. The vent hole 91 may be a thinner area than other areas of the pouch 90 so that it can be normally blocked and be open first when the internal pressure of the pouch 90 increases.

The vent hole 91 may be arranged on an area of the base plate 20 having no resin 40. Accordingly, the vent holes 91 of some pouches 90 may be arranged corresponding to the base vent hole 23 but the vent holes 91 of the other pouches 90 may be arranged distant from the base vent hole 23.

Gas discharged from the pouch 90 through the vent hole 91 arranged at the position corresponding to the base vent hole 23 may be discharged outside through the corresponding base vent hole 23. As described above, gas discharged through the vent hole arranged distant from the base vent hole 23 may flow into the space between two adjacent base vent holes 23 not coated by the resin 40 and then discharged outside through base vent hole 23 positioned nearby.

The gas leaking from the pouch 90 may be discharged by the pack vent through the base vent hole 23, the corresponding vent hole 33, the beam vent hole 53, the beam hollow portion 51, the edge vent hole 55, the beam connection hole 65, and the frame hollow portion 67 in flow order.

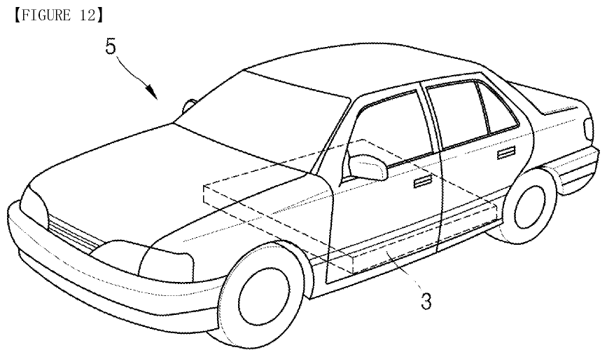

Referring to FIG. 12, the batter pack 3 including the lower case 10 may be mounted in a lower portion of the vehicle 5.

According to the above-noted description, since the support beam having a low height provided in a lower area of the secondary battery accommodating space inside the lower case reinforce the rigidity of the lower case and the venting path of leaking gas at the same time, the structure for reinforcing rigidity and the structure for discharging gas may not occupy the space for accommodating the secondary battery. Accordingly, the space for accommodating the secondary battery may be further secured and the electricity capacity of the battery pack may be further increased.

Due to the structure, a moveable distance of the vehicle may be further increased when the above-described battery pack is mounted in the vehicle.

It should be understood that the described embodiments are illustrative in all respects and not restrictive, and the scope of the present disclosure will be indicated by the following claims rather than the described detailed description. And the meaning and scope of the claims to be described later, as well as all changes and modifications derived from the equivalent concept should be interpreted as being included in the scope of the present disclosure.

Although the present disclosure has been described with reference to the exemplified drawings, it is to be understood that the present disclosure is not limited to the embodiments and drawings disclosed in this specification, and those skilled in the art will appreciate that various modifications are possible without departing from the scope and spirit of the present disclosure. Further, although the operating effects according to the configuration of the present disclosure are not explicitly described while describing an embodiment of the present disclosure, it should be appreciated that predictable effects are also to be recognized by the configuration.

1. A battery pack comprising:
a quadrilateral lower case extending in a first direction and a second direction crossing the first direction,
wherein the lower case comprises:
a quadrilateral base plate;
a quadrilateral under cover spaced apart from the base plate and to face the base plate;
a side pack frame connected to an edge of the base plate and an edge of the under cover, and configured to form a periphery of the lower case;
a support beam provided between the base plate and the under cover, and extending in the first direction;
a wall frame included in the side pack frame; and
a plurality of pouches disposed inside a space surrounded by the wall frame.

2. The battery pack of claim 1, wherein the plurality of pouches are disposed such that no member for reinforcing rigidity of the lower case is disposed between two pouches adjacent to each other in the first direction or the second direction.

3. The battery pack of claim 1, wherein the plurality of pouches are in contact with each other in the second direction.

4. The battery pack of claim 1, wherein the support beam is provided in plural, and
the plurality of support beams are spaced apart from each other in the second direction.

5. The battery pack of claim 4, wherein the plurality of support beams are parallel with each other.

6. The battery pack of claim 1, wherein both extension-direction ends of the support beam are connected to respective sides of the side pack frame.

7. The battery pack of claim 1, comprising a base vent hole provided at a predetermined area of the base plate facing the support beam, and
a beam vent hole provided at an upper surface of the support beam facing the base vent hole, and
the base vent hole and the beam vent hole are in communication with each other.

8. The battery pack of claim 7, wherein
the support beam comprises a beam hollow portion that is hollow along a direction in which the support beam extends, and
the beam vent hole and the beam hollow portion are in communication with each other.

9. The battery pack of claim 8, comprising an end vent hole provided at one end of at least one side of the support beam, and
the beam hollow portion and the end vent hole are in communication with each other.

10. The battery pack of claim 9, comprising a beam connection hole provided at an area where the side pack frame and the support beam are connected to each other, and the beam connection hole is in communication with the end vent hole.

11. The battery pack of claim 10, wherein the side pack frame comprises a frame hollow portion extending in a second direction, and
the frame hollow portion is in communication with the beam connection hole.

12. The battery pack of claim 11, wherein the lower case comprises a pack vent configured to discharge gas from a pouch, and
the frame hollow portion is in communication with the pack vent.

13. The battery pack of claim 7, wherein the base plate and a pouch are secured to each other by a resin disposed between the base plate and the pouch, and
the resin is not disposed at an area in which a plurality of base vent holes are arranged along the second direction.

14. The battery pack of claim 13, comprising a vent hole is provided at a position corresponding to the area where the resin is not disposed at a lower surface of the pouch, and configured to discharge gas generated inside the pouch to an outside of the pouch.

15. The battery pack of claim 1, comprising a cooling plate disposed at a lower surface of the base plate and a cooling path provided at the cooling plate, and
the support beam is disposed lower than the cooling plate.

16. The battery pack of claim 15, comprising a base vent hole provided at an area at the base plate where the cooling path is not disposed.

17. The battery pack of claim 16, comprising a corresponding vent hole provided at an area facing the base vent hole at the cooling plate, and
the base vent hole and the corresponding hole are in communication with each other.

18. A vehicle comprising the battery pack of claim 1.
